(19) United States
(12) Patent Application Publication
(10) Pub. No.: US 2016/0380560 A1
(43) Pub. Date: Dec. 29, 2016

(54) FLUID EXTRACTION SYSTEM HAVING POWER CONTROL SUB-SYSTEM AND RELATED METHODS

(71) Applicant: General Electric Company, Schenectady, NY (US)

(72) Inventor: David Allan Torrey, Ballston Spa, NY (US)

(21) Appl. No.: 14/753,361

(22) Filed: Jun. 29, 2015

(51) Int. Cl. H02P 5/68; E21B 43/12; E21B 34/06; H02J 1/00; E21B 41/00

(52) U.S. Cl. CPC H02P 5/68; H02J 1/00; E21B 41/00; E21B 34/066; E21B 43/128

(57) ABSTRACT

A power control sub-system for controlling a plurality of electric machines disposed in a well is disclosed. The power control sub-system includes at least one power cable configured to conduct a direct current to and/or from one or more electric machines of the plurality of electric machines. The power control sub-system further includes a switching device disposed proximate to one or more of the plurality of electric machines in the well, where the switching device is electrically coupled to the at least one power cable and the plurality of electric machines, and where the switching device is capable of withstanding high temperatures and is configured to selectively control supply of the direct current to and/or from one or more electric machines of the plurality of electric machines. A fluid extraction system employing the power control sub-system and a method of controlling the plurality of electric machines are also disclosed.

### BACKGROUND

Embodiments of the present disclosure relate to a fluid extraction system, and more particularly to a fluid extraction system having a power control sub-system and related methods for controlling a plurality of electric machines disposed in a well using the power control sub-system.

In oil and/or gas mining operations, electric machines, such as electric submersible pumps (ESPs), are prevalently used to extract the oil and/or gas from a well. The ESPs may be disposed in the well to remove the oil and/or gas. With advancements in the technology, currently, ESPs that are operable using a direct current (DC) input are being used. In presently available fluid extraction systems, the direct current to each ESP is typically supplied by using a separate set of power cables. The power cables extend from one or more DC power sources disposed outside the well to the ESPs that are disposed in the well. The power cables extend into the well to respective ESPs in order to conduct the direct current from the DC power sources to the respective ESPs. Other electrically actuated loads/machines such as valves may also be located in the well. Operation of such loads may be enhanced by supplying DC power to these electrically actuated loads/machines.

Moreover, as the ESPs are located far from the DC power sources, the power cables that supply the current to the ESPs are also required to be very long. As the length of the cables increases, the cost to provide power to the ESPs also increases. In certain instances, the cost of providing such long power cables may constitute a significant portion of an overall cost of the fluid extraction system.

Additionally, the environment within the well, where the ESPs are located may be harsh. For example, the ESPs used in such environment may be exposed to temperatures in excess of 180 degrees Celsius, pressure differentials on the order of 5,000 pounds per square inch, mechanical vibrations, and the like. Consequently, ensuring a reliable operation of the fluid extraction system is also a challenge.

### BRIEF DESCRIPTION

In accordance with aspects of the present specification, a power control sub-system for controlling a plurality of electric machines disposed in a well is provided. The power control sub-system includes at least one power cable configured to conduct a direct current to one or more electric machines of the plurality of electric machines. The power control sub-system further includes a switching device disposed proximate to one or more of the plurality of electric machines in the well, where the switching device is electrically coupled to the at least one power cable and the plurality of electric machines. Further, the switching device is capable of withstanding high temperatures and is configured to selectively control supply of the direct current to one or more electric machines of the plurality of electric machines.

In accordance with another aspect of the present specification, a fluid extraction system is provided. The fluid extraction system includes a plurality of electric machines configured to extract a fluid from a well. The fluid extraction system further includes a power control sub-system operatively coupled to the plurality of electric machines and configured to control the plurality of electric machines. The power control sub-system includes at least one power cable configured to conduct a direct current to one or more electric machines of the plurality of electric machines. The power control sub-system also includes a switching device disposed proximate to one or more of the plurality of electric machines in the well, where the switching device is electrically coupled to the at least one power cable and the plurality of electric machines. Further, the switching device is capable of withstanding high temperatures and configured to selectively control the supply of the direct current to one or more electric machines of the plurality of electric machines. Moreover, the power control sub-system includes a controller operatively coupled to the switching device and configured to control the switching device such that the supply of direct current to one or more electric machines of the plurality of electric machines is selectively controlled.

In accordance with another aspect of the present specification, a method for controlling a plurality of electric machines disposed in a well is presented. The method includes conducting a direct current to one or more electric machines of the plurality of electric machines using at least one cable. The method further includes selectively controlling supply of the direct current to one or more electric machines of the plurality of electric machines using a switching device disposed proximate to one or more of the plurality of electric machines in the well.

### DRAWINGS

These and other features, aspects, and advantages of the present specification will become better understood when the following detailed description is read with reference to the accompanying drawings in which like characters represent like parts throughout the drawings, wherein:

FIG. 1 is a diagrammatical illustration of a fluid extraction system, in accordance with aspects of the present specification;

FIG. 2 is a diagrammatical illustration of a switching device, in accordance with aspects of the present specification;

FIG. 3 is a diagrammatical illustration of another switching device, in accordance with aspects of the present specification; and

FIG. 4 is a flow chart illustrating an example method of controlling a plurality of electric machines used in the fluid extraction system of FIG. 1, in accordance with aspects of the present specification.

### DETAILED DESCRIPTION

The specification may be best understood with reference to the detailed figures and description set forth herein. Various embodiments are described hereinafter with reference to the figures. However, those skilled in the art will readily appreciate that the detailed description given herein with respect to these figures is for explanatory purposes as the method and the system may extend beyond the described embodiments.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

In accordance with some aspects of the present specification, a fluid extraction system is presented. The fluid extraction system includes a plurality of electric machines configured to extract a fluid from a well. The fluid may be liquid, gas, or a combination thereof. The fluid extraction system further includes a power control sub-system operatively coupled to the plurality of electric machines and configured to control the plurality of electric machines. The power control sub-system includes at least one power cable configured to conduct a direct current to one or more electric machines of the plurality of electric machines. The power control sub-system also includes a switching device disposed proximate to one or more of the plurality of electric machines in the well. The switching device is electrically coupled to the at least one power cable and the plurality of electric machines. Furthermore, the switching device is capable of withstanding high temperatures and configured to selectively control the supply of the direct current to one or more electric machines of the plurality of electric machines. Moreover, the power control sub-system includes a controller operatively coupled to the switching device and configured to control the switching device such that the supply of direct current to one or more electric machines of the plurality of electric machines is selectively controlled. Additionally, the switching device may be configured to selectively control the supply of the direct current from one or more electric machines of the plurality of electric machines to the at least one power cable. Also, the switching device may be configured to selectively control the supply of the direct current both to and from the one or more electric machines of the plurality of electric machines.

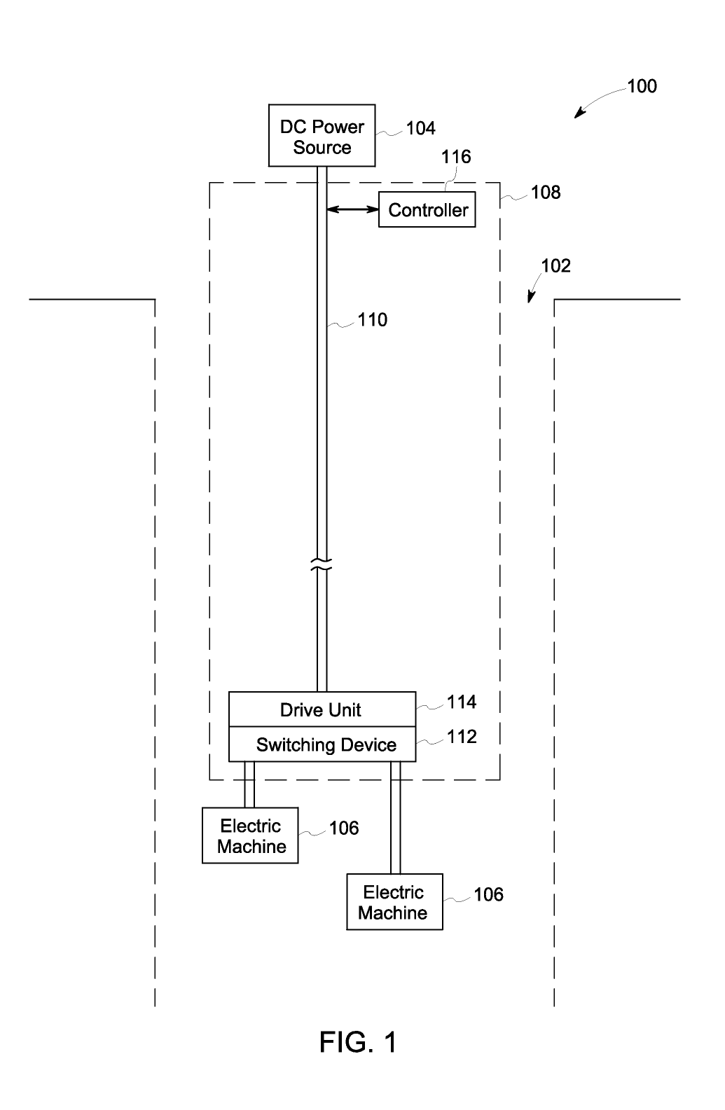

FIG. 1 is a diagrammatical illustration of a fluid extraction system 100, in accordance with aspects of the present specification. The fluid extraction system 100 is used to extract fluids, such as, but not limited to, oil and/or gas, from a well 102. The fluid extraction system 100 may include one or more direct current (DC) power sources such as a DC power source 104, a plurality of electric machines 106, and a power control sub-system 108. The power control sub-system 108 may include at least one power cable such as a power cable 110, a switching device 112, a drive unit 114, and a controller 116.

The DC power source 104 may be representative of a power generation and/or distribution system operable to generate and/or distribute a direct current to the electric machines 106. By way of example, the DC power source 104 may include a high voltage DC (HVDC) generation and/or distribution system, a medium voltage DC (MVDC) generation and/or distribution system, a solar power plant, a wind based power plant, energy storage mediums such as batteries, voltage and/or current converters, voltage regulators, and the like.

The electric machines 106 may be coupled to the DC power source 104 via the power control sub-system 108. In one embodiment, the power cable 110 may include a pair of electric conductors, where one electric conductor may carry a positive DC current, while other electric conductor may carry a negative DC current.

As previously noted, the electric machines 106 may be disposed in the well 102 to extract the oil and/or gas. In one embodiment, the electric machines 106 may be electrically operable machines, devices, or apparatus that are operable at least within the well 102. Non-limiting examples of the electric machine 106 may include an electric submersible pump (ESP), an electric motor, an electrically operable valve, or combinations thereof. In some embodiments, the electric machine 106 may be integrated within the ESP. For example, in certain embodiments, the electric motor and/or the electrically operable valve may be integrated within the ESP. In certain embodiments, the electric machine 106 may be disposed outside of the ESP.

Moreover, in some embodiments, the electric machines 106 may be operable by the direct current received over the power cable 110. However, in some embodiments, the electric machines 106 may be operable using an alternating current. In some of these embodiments, the electric machines 106 may include electronics for converting the direct current to the alternating current. In the description hereinafter, the electric machines 106 have been described as the ESPs, for ease of illustration. Also, although two electric machines 106 are shown in FIG. 1, greater number of electric machines 106 may be employed, without limiting the scope of the present specification.

The power control sub-system 108 may be used to control a supply of the direct current from the DC power source 104 to the electric machines 106. It is to be noted that while one or more components of the power control sub-system 108 may be disposed outside the well 102, other components of the power control sub-system 108 may be disposed inside the well 102. By way of example, the controller 116 may be disposed outside the well 102 while the switching device 112 and/or the drive unit 114 may be disposed in the well 102. More particularly, the switching device 112 and/or the drive unit 114 may be disposed along with the electric machines 106 or proximate to the electric machines 106. Moreover, the power cable 110 may remain at least partially outside the well 102 and at least partially inside the well 102, as depicted in FIG. 1. As will be appreciated, the power cable 110 is shown in a discontinuous form to represent long length of the power cable 110.

It is to be noted that the environment within the well 102 may be harsh. The harsh environment of the well 102 may be characterized by high temperature (e.g., temperatures of 180 degrees Celsius or more), high pressure (e.g., up to 5000 psi), high vibrations, and the like. Consequently, components of the fluid extraction system 100, such as the electric machines 106, the switching device 112, and/or the drive unit 114 that are disposed in the well 102, may require to be operated in such harsh environment while supporting medium or high voltages (e.g., a few kVs to a few tens of kVs) and increased power demands.

In the power control sub-system 108, the controller 116 may be coupled to the drive unit 114. The controller 116 may include a specially programmed general purpose computer, a microprocessor, a digital signal processor, and/or a microcontroller. The controller 116 may also include input/output ports and a storage medium, such as, an electronic memory. Various examples of the microprocessor include, but are not limited to, a reduced instruction set computing (RISC) architecture type microprocessor or a complex instruction set computing (CISC) architecture type microprocessor. Further, the microprocessor may be of a single-core type or multi-core type.

In order to control the supply of the DC current to and/or from the electric machines 106, the controller 116 is configured to control operation of the switching device 112. The controller 116 may control the operation of the switching device 112 via the drive unit 114. More particularly, the controller 116 is configured to control the switching device 112 such that the supply of the direct current to and/or from one or more electric machines of the electric machines 106 is selectively controlled. In the embodiment of FIG. 1, the controller 116 is shown as being coupled to the drive unit 114 via the power cable 110. However, in alternative embodiments, the controller 116 may be coupled to the drive unit 114 using a separate cable. In yet another embodiment, the controller 116 may be wirelessly coupled to the drive unit 114. In some embodiments, depending on system requirements including, but not limited to, operating hours, required flow rate, priorities corresponding to the electric machines 106, and the like, the controller 116 may be configured to communicate control signals to the drive unit 114. Further, communication between the controller 116 and the drive unit 114 may be enabled using power line communication techniques.

In certain embodiments, the drive unit 114 is operatively coupled to the switching device 112. More particularly, the drive unit 114 may be coupled to one or more control terminals (not shown in FIG. 1) of the switching device 112. In some embodiments, the drive unit 114 may be configured to receive the control signals from the controller 116 and adjust voltage levels at the one or more control terminals of the switching device 112 in response to the received control signals.

As previously noted, the switching device 112 may be disposed proximate to one or more of the electric machines 106 in the well 102. The switching device 112 may be electrically coupled to the power cable 110, the electric machines 106, and the drive unit 114. More particularly, the switching device 112 may be configured to selectively control the supply of the direct current to and/or from one or more electric machines of the plurality of electric machines 106 under the control of the controller 116. In one embodiment, the switching device 112 may be configured to selectively control the supply of the direct current such that two or more electric machines 106 are operated simultaneously. In another embodiment, the switching device 112 may be configured to selectively control the supply of the direct current such that at least one electric machine of the electric machines 106 is operated at an operating condition that is different from an operating condition corresponding to other electric machines of the electric machines 106. For example, the operating condition may be a rotational speed of impellers (not shown) used in the electric machines 106, such as ESPs.

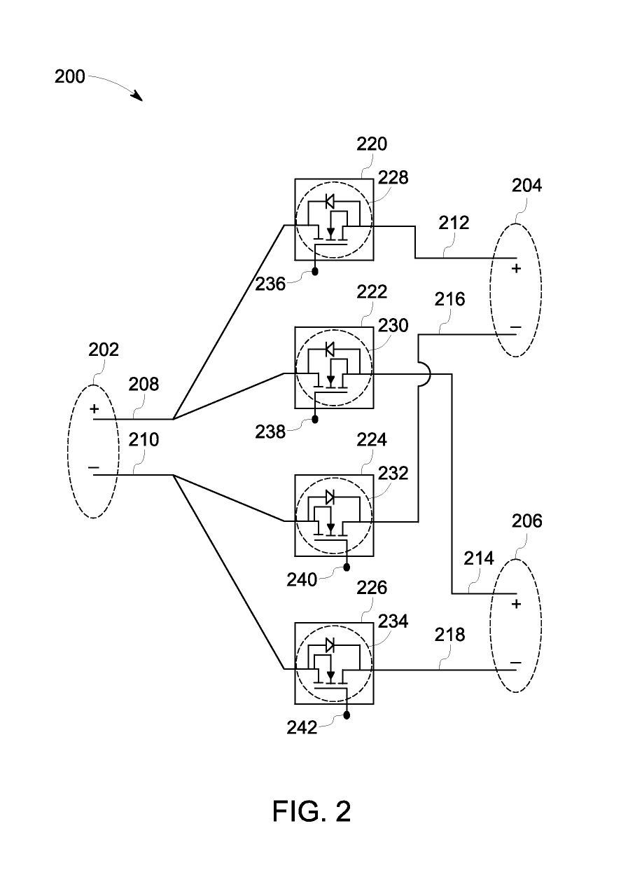

FIG. 2 is a diagrammatical illustration of a switching device 200, in accordance with aspects of the present specification. More particularly, the switching device 200 may be representative of one embodiment of the switching device 112 of FIG. 1. Accordingly, FIG. 2 is described with reference to FIG. 1.

Reference numeral 202 represents a DC input port of the switching device 200, while reference numerals 204 and 206 represent DC output ports of the switching device 200. The switching device 200 may be coupled to a power cable, such as the power cable 110 of FIG. 1, at the DC input port 202 of the switching device 200. Moreover, each of the DC output ports 204 and 206 of the switching device 200 may be coupled to respective one of electric machines, such as the electric machines 106, of FIG. 1. In the presently contemplated embodiment, as the two electric machines 106 are used, two DC output ports may be desired. Consequently, the switching device 200 is shown as having the two DC output ports 204 and 206. However, use of greater number of DC output ports is also envisioned when more than two electric machines 106 may need to be controlled.

In one embodiment, the DC input port 202 may include a positive input electric path 208 and a negative input electric path 210. The DC output port 204 may include an output electric path 212 and an output electric path 216. Similarly, the DC output port 206 may include an output electric path 214 and an output electric path 218. In the illustrated embodiment, the output electric paths 212 and 214 represent positive DC output lines, while the output electric paths 216 and 218 may represent a negative DC output lines.

The switching device 200 may further include a plurality of switching units 220, 222, 224, and 226 coupled between the DC input port 202 and the DC output ports 204 and 206. The switching units 220-226 are configured to electrically connect or disconnect the output electric paths 212-218 to the input electric paths 208 and 210. More particularly, the switching unit 220 is coupled between the input electric path 208 and the output electric path 212 and is configured to electrically connect or disconnect the input electric path 208 and the output electric path 212. The switching unit 222 is coupled between the input electric path 208 and the output electric path 214 and is configured to electrically connect or disconnect the input electric path 210 and the output electric path 214. The switching unit 224 is coupled between the input electric path 210 and the output electric path 216 and is configured to electrically connect or disconnect the input electric path 208 and the output electric path 216. Similarly, the switching unit 226 is coupled between the input electric path 210 and the output electric path 218 and is configured to electrically connect or disconnect the input electric path 210 and the output electric path 218.

For ease of illustration, only four switching units 220-226 are shown, however, greater number of switching units may also be employed, without limiting the scope of the present specification. More particularly, in one embodiment, the number of switching units may be determined based on a required number of DC output ports, which in turn corresponds to a number of electric machines used in a fluid extraction system such as the fluid extraction system 100. In one embodiment, the number of switching units may be twice the number of DC output ports.

Moreover, the switching units 220-226 may include power semiconductor switches such as power semiconductor switches 228, 230, 232, and 234, respectively. Examples of the power semiconductor switches 228-234 may include, but are not limited to, transistors, gate commutated thyristors, field effect transistors, insulated gate bipolar transistors, gate turn-off thyristors, static induction transistors, static induction thyristors, or combinations thereof. In the illustrated embodiment of FIG. 2, field effect transistors such as metal oxide semiconductor field effect transistors (MOSFETs) having respective body diodes are used as the power semiconductor switches 228-234. In one embodiment, the power semiconductor switches 228-234 may be formed using a wide band-gap semiconductor material. Advantageously, the power semiconductor switches 228-234 formed using the wide band-gap semiconductor material are capable of withstanding high temperatures within a well such as the well 102. By way of example, the power semiconductor switches 228-234 may be formed using materials including, but not limited to, silicon (Si), silicon carbide (SiC), gallium nitride (GaN), or combinations thereof.

For ease of illustration, each of the switching units 220-226 are shown as having a single power semiconductor switch. However, in certain instances, in order to withstand high voltage and current requirements, more than one power semiconductor switches may also be used in one or more of the switching units 220-226. In some embodiments, in a switching unit, two or more power semiconductor switches may be electrically coupled in series with one another to withstand high voltage levels. Alternatively, in some other embodiments, in the switching unit, the two or more power semiconductor switches may be electrically coupled in parallel with one another to facilitate a supply of the high current. Moreover, in certain embodiments, use of both high voltage and high current may be desired. In such instances, a combination of series and parallel coupling of the two or more power semiconductor switches may be utilized.

Further, reference numerals 236, 238, 240, and 242 may represent control terminals (e.g., gate terminals), respectively, of the power semiconductor switches 228-234. As previously noted, a drive unit, such as the drive unit 114, may be coupled to the control terminals 236-242 to respectively control switching of the power semiconductor switches 228-234.

During operation, based on a control signal from the controller 116, if it is determined that an electric machine 106 coupled to the DC output port 204 needs to be operated and another electric machine 106 coupled to the DC output port 206 needs to be turned-off or maintained in a non-operating condition, the drive unit 114 may be configured to provide suitable control voltages at selected control terminals of the control terminals 236-242. In one embodiment, the control voltages are such that the power semiconductor switches 228 and 232 are turned-on and the power semiconductor switches 230 and 234 are turned-off. Consequently, the DC current from the DC input port 202 may be supplied to the electric machine 106 coupled to the DC output port 204, while the DC current to the DC output port 206 is blocked.

Based on another control signal from the controller 116, if it is determined that the electric machine 106 coupled to the DC output port 204 needs to be turned-off and the electric machine 106 coupled to the DC output port 206 needs to be operated, the drive unit 114 may be configured to provide a suitable control voltages at the control terminals 236-242. In one embodiment, the control voltages are such that the power semiconductor switches 228 and 232 are turned-off and the power semiconductor switches 230 and 234 are turned-on. Consequently, the DC current from the DC input port 202 may be supplied to the electric machine 106 coupled to the DC output port 206, while the DC current to the DC output port 204 is blocked.

Moreover, based on yet another control signal from the controller 116, if it is determined that both the electric machines 106 coupled to the DC output ports 204 and 206 need to be operated, the drive unit 114 may be configured to provide suitable control voltages at the control terminals 236-242. In one embodiment, the control voltages are such that all the power semiconductor switches 228-234 are turned-on. Consequently, the DC current from the DC input port 202 may be supplied to both the electric machines 106.

As will be appreciated, in some instances, the electric machines 106, for example ESPs, may also be operated as generators. Accordingly, in certain embodiments, it may be desired to allow a flow of electricity generated by one or more of electric machines 106 back to a power source, such as the DC power source 104. In some embodiments, electricity generated by one or more electric machines 106 may be used to raise DC voltage level of the power cable 110. In order to facilitate such a back flow of the electricity from one or more of the electric machines 106, the power semiconductor switches 228-234 are capable of supporting a bi-directional flow of current from the one or more of the electric machines 106.

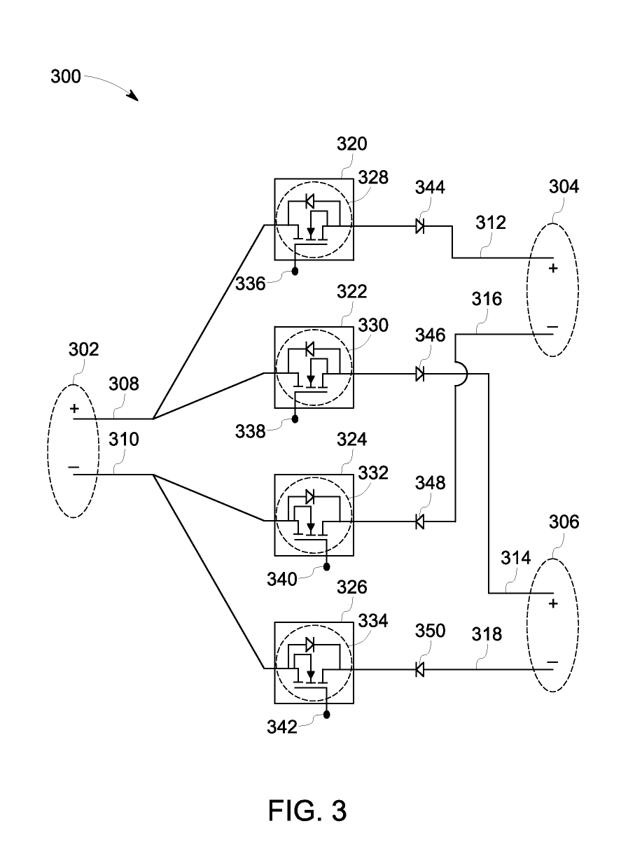

FIG. 3 is a diagrammatical illustration of another switching device 300, in accordance with aspects of the present specification. The switching device 300 may be representative of another embodiment of the switching device 112 of FIG. 1. More particularly, switching device 300 of FIG. 3 may be employed in the fluid extraction system 100 when a back flow of electricity generated by the electric machines 106 is not desired.

In certain embodiments, the switching device 300 may include an input port 302 and output ports 304 and 306. The DC input port 302 may include input electric paths 308 and 310. The DC output port 304 may include electric paths 312 and 316, while the DC output port 306 may include electric paths 314 and 318. Further, switching units 320, 322, 324, and 326, are employed to electrically connect or disconnect the output electric paths 312-318, respectively, from input electric paths 308 and 310. The switching units 320-326 may include power semiconductor switches 328, 330, 332, and 334, respectively, as depicted in FIG. 3. Moreover, reference numerals 336, 338, 340, and 342 represent control terminals of the power semiconductor switches 328-342, respectively.

Additionally, one or more output electric path of the output electric paths 312-318 may also include a diode coupled in series with respective switching unit of the switching units 320-326. For example, diodes 344, 346, 348, and 350 are respectively coupled in series with the switching units 320-326. More particularly, the diodes 344-350 are coupled such that a flow of current from the output ports 304 and 306 to the input port 302. The flow of current from the output ports 304 and 306 to the input port 302 may be blocked irrespective of operating conditions (e.g., ON or OFF) of the power semiconductor switches 328-334.

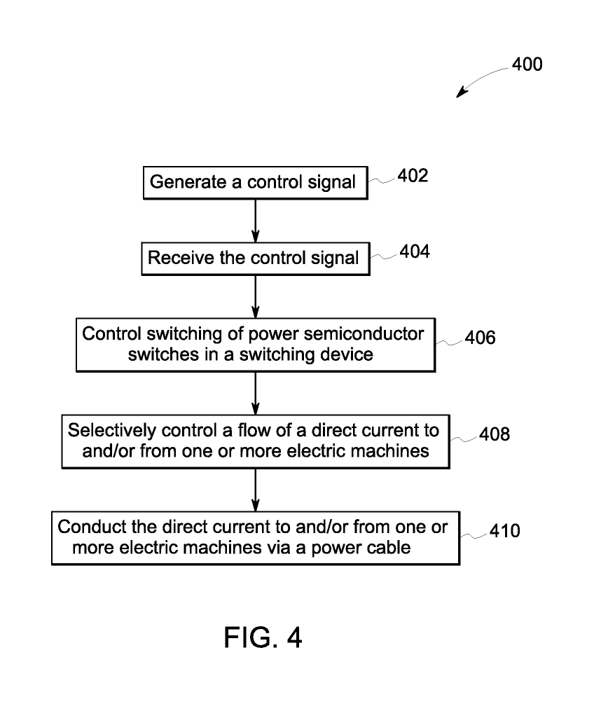

FIG. 4 is a flow chart 400 illustrating an example method of controlling a plurality of electric machines, such as the electric machines 106, used in a fluid extraction system, such as the fluid extraction system 100 of FIG. 1, in accordance with aspects of the present specification. For ease of illustration, the flow chart 400 of FIG. 4 is explained in conjunction with FIGS. 1 and 2.

At step 402, a control signal may be generated. In one embodiment, the control signal may be generated by a controller, such as the controller 116 that is disposed outside a well, such as the well 102. As previously noted, the control signal may be generated based on parameters including, but not limited to, operating hours, required flow rate, priorities corresponding to the electric machines 106, and the like.

Further, at step 404, the control signal may be received by a drive unit, such as the drive unit 114, that is disposed in the well 102 proximate to one or more of the electric machines 106. Once the control signal is received, switching of power semiconductor switches, such as the power semiconductor switches 224-230, in a switching device, such as the switching device 200, may be controlled, at step 406. In one embodiment, the switching of power semiconductor switches 224-230 may be controlled by applying appropriate voltages at respective control terminals, as noted hereinabove. In one embodiment, the drive unit 114 may apply the voltages at control terminals 236-242 of the power semiconductor switches 228-234.

Accordingly, at step 408, a flow of a direct current to and/or from one or more electric machines of the electric machines 106 may be selectively controlled. In one embodiment, the flow of the direct current may be controlled such that two or more electric machines 106 are operated simultaneously. In another embodiment, the flow of the direct current may be controlled such that at least one electric machine of the electric machines 106 is operated at an operating condition (e.g., speed) that is different from an operating condition corresponding to other electric machines of the electric machines 106. At step 410, the direct current to and/or from the one or more electric machines may be conducted via a power cable, such as the power cable 110.

Any of the foregoing steps and/or system elements may be suitably replaced, reordered, or removed, and additional steps and/or system elements may be inserted, depending on the needs of a particular application, and that the systems of the foregoing embodiments may be implemented using a wide variety of suitable processes and system elements and are not limited to any particular computer hardware, software, middleware, firmware, microcode, and the like.

The systems and methods described herein aids in reducing overall cost of an infrastructure. For example, in the fluid extraction system 100, a single power cable is used to control the plurality of electric machines 106 resulting in reduced costs of power cables used to power the electric machines 106. One or more electric machines of the plurality of electric machines 106 may be used as backup electric machines in instances where a primary electric machine(s) malfunctions or fails to operate. In such instances, the switching device 112 may be configured to activate one or more of the backup to maintain the operation of the fluid extraction system 100 as desirable. Additionally, as the power semiconductor switches employed in the power control sub-system 108 are formed using a wide band-gap semiconductor material, the fluid extraction system 100 may be reliably operated even at high temperatures in the well 102. Moreover, the power control sub-system 108 of the present specification does not require a complex signal processing within the well 102, thereby avoiding a use of complex electronics including but not limited to processors or controllers within the well. Consequently, in addition to being reliable at high temperatures, the power control sub-system 108 may be less prone to mechanical vibrations and pressure differentials within the well 102, resulting in a more reliable operation of the fluid extraction system 100.

It will be appreciated that variants of the above disclosed and other features and functions, or alternatives thereof, may be combined to create many other different systems or applications. Various unanticipated alternatives, modifications, variations, or improvements therein may be subsequently made by those skilled in the art and are also intended to be encompassed by the following claims.

1. A power control sub-system for controlling a plurality of electric machines disposed in a well, the power control sub-system comprising:
at least one power cable configured to conduct a direct current to one or more electric machines of the plurality of electric machines; and
a switching device disposed proximate to one or more of the plurality of electric machines in the well, wherein the switching device is electrically coupled to the at least one power cable and the plurality of electric machines, and wherein the switching device is capable of withstanding high temperatures and configured to selectively control supply of the direct current to one or more electric machines of the plurality of electric machines.

2. The power control sub-system of claim 1, wherein the switching device is further configured to selectively control the supply of the direct current from one or more electric machines of the plurality of electric machines to the at least one power cable.

3. The power control sub-system of claim 1, wherein the switching device comprises a plurality of switching units operatively coupled to one or more electric machines of the plurality of electric machines, and wherein the plurality of switching units is configured to selectively control the supply of the direct current to the one or more electric machines.

4. The power control sub-system of claim 3, wherein one or more switching units of the plurality of switching units comprise one or more power semiconductor switches.

5. The power control sub-system of claim 4, wherein the one or more power semiconductor switches are arranged in series with one another, parallel with one another, or a combination thereof.

6. The power control sub-system of claim 4, wherein the one or more power semiconductor switches comprise transistors, gate commutated thyristors, field effect transistors, insulated gate bipolar transistors, gate turn-off thyristors, static induction transistors, static induction thyristors, or combinations thereof.

7. The power control sub-system of claim 4, wherein the one or more power semiconductor switches are made of silicon (Si), silicon carbide (SiC), gallium nitride (GaN), or combinations thereof.

8. The power control sub-system of claim 4, further comprising a drive unit disposed in the well and operatively coupled to the switching device, wherein the drive unit is configured to control switching of the one or more power semiconductor switches.

9. The power control sub-system of claim 1, further comprising a controller disposed outside the well and operatively coupled to the switching device, wherein the controller is configured to control the switching device such that the supply of direct current to one or more electric machines of the plurality of electric machines is selectively controlled.

10. The power control sub-system of claim 1, wherein the switching device is configured to selectively control the supply of the direct current to the plurality of electric machines such that two or more electric machines of the plurality of electric machines are operated simultaneously.

11. The power control sub-system of claim 1, wherein the switching device is configured to selectively control the supply of the direct current to the plurality of electric machines such that at least one electric machine of the plurality of electric machines is operated at an operating condition that is different from an operating condition corresponding to other electric machines of the plurality of electric machines.

12. A fluid extraction system, comprising:
a plurality of electric machines configured to extract a fluid from a well; and
a power control sub-system operatively coupled to the plurality of electric machines and configured to control the plurality of electric machines, the power control sub-system comprising:
at least one power cable configured to conduct a direct current to one or more electric machines of the plurality of electric machines;
a switching device disposed proximate to one or more of the plurality of electric machines in the well, wherein the switching device is electrically coupled to the at least one power cable and the plurality of electric machines, and wherein the switching device is capable of withstanding high temperatures and configured to selectively control the supply of the direct current to one or more electric machines of the plurality of electric machines; and
a controller operatively coupled to the switching device and configured to control the switching device such that the supply of direct current to one or more electric machines of the plurality of electric machines is selectively controlled.

13. The fluid extraction system of claim 12, wherein an electric machine of the plurality of electric machines comprises an electric submersible pump, an electric motor, an electrically operable valve, or combinations thereof.

14. The fluid extraction system of claim 13, wherein one or more of the electric motor and the electrically operable valve are integrated into the electric submersible pump.

15. The fluid extraction system of claim 12, wherein the fluid comprises a liquid, a gas, or a combination thereof.

16. The fluid extraction system of claim 12, wherein the power control system further comprises a drive unit disposed in the well and operatively coupled to the switching device and the controller, wherein the drive unit is configured to control switching of one or more power semiconductor switches of the switching device.

17. A method for controlling a plurality of electric machines disposed in a well, the method comprising:
selectively controlling supply of a direct current to one or more electric machines of the plurality of electric machines using a switching device disposed proximate to one or more of the plurality of electric machines in the well; and
conducting the direct current to the one or more electric machines of the plurality of electric machines using at least one power cable.

18. The method of claim 17, further comprising receiving a control signal, by a gate drive unit disposed in the well, from a controller disposed outside the well, wherein the gate drive unit is operatively coupled to the controller and the switching device.

19. The method of claim 18, wherein the supply of the direct current to the one or more electric machines is selectively controlled based on the control signal.

20. The method of claim 17, further comprising selectively controlling the supply of the direct current such that two or more electric machines of the plurality of electric machines are operated simultaneously.

21. The method of claim 17, further comprising selectively controlling the supply of the direct current such that at least one electric machine of the plurality of electric machines is operated at an operating condition that is different from an operating condition corresponding to other electric machines of the plurality of electric machines.
